(19) United States
(12) Patent Application Publication
(10) Pub. No.: US 2023/0052104 A1
(43) Pub. Date: Feb. 16, 2023

(54) VIRTUAL CONTENT EXPERIENCE SYSTEM AND CONTROL METHOD FOR SAME

(71) Applicant: BELIVVR. Inc., Suncheon-si, Jeollanam-do (KR)

(72) Inventor: Byoung Seok YANG, Gunpo-si (KR)

(73) Assignee: BELIVVR. Inc., Suncheon-si, Jeollanam-do (KR)

(21) Appl. No.: 17/780,281

(22) PCT Filed: Nov. 25, 2020
(86) PCT No.: PCT/KR2020/016823

§ 371 Date: May 26, 2022

(30) Foreign Application Priority Data
Nov. 29, 2019 (KR) 10-2019-0156510

(51) Int. Cl. H04N 13/282; G06T 7/11; H04N 5/232; H04N 13/261; H04N 13/332; H04N 13/378; G06F 3/01

(52) U.S. Cl. CPC H04N 13/282; G06T 7/11; H04N 5/23238; H04N 13/261; H04N 13/332; H04N 13/378; G06F 3/013; G06T 2207/10028

(57) ABSTRACT

Disclosed is a virtual content experience system. In the virtual content experience system, a central server for driving the system contains: a content conversion unit which converts two-dimensional image content, received by means of a data transmission and reception unit or input by a user, into a stereoscopic image; a motion information generation unit which recognizes text information extracted from the two-dimensional image content and converts the text information into motion information; a content playback control unit which is provided to transmit the motion information to a motion information management unit provided in a virtual reality experience chair, or receive start information and end information about the motion information from the motion information management unit to generate and change control information for controlling whether to provide new two-dimensional image content; and a display unit for displaying the content conversion unit, and the motion information or control information.

### CROSS REFERENCE TO RELATED APPLICATIONS

This application is a National Stage of International Application No. PCT/KR2020/016823 filed Nov. 25, 2020, claiming priority based on Korean Patent Application No. 10-2019-0156510 filed Nov. 29, 2019.

### TECHNICAL FIELD

The present disclosure relates to an experience system for experiencing virtual reality and a method for controlling the same, and more particularly, to a virtual content experience system and a method for controlling the same which can transform a 2-dimensional image to a stereoscopic image and provide a posture change therefor.

### BACKGROUND ART

A head mounted display (HMD) device is provided in the form in which a terminal device which can play a 360 degree 3-dimensional image is installed. When a user mounts the HMD device on the user's head and drives the terminal device, a 3-dimensional image, that is, virtual reality content is played on a screen of the terminal device. The HMD device is provided with various types of sensors such as a Gyro sensor and provides 3-dimensional image that corresponds to a motion of the user based on the sensors.

The HMD device enables the user to experience virtual reality and to experience the sight of the user focused on a virtual space, and when the user mounts the HMD device, the motion of the user is restricted.

The virtual content experience device is also provided to experience virtual reality using hearing or touch in addition to sight. However, since the most important feeling of the user is sight, the virtual content experience device that uses the HMD device provided while the sight of the user is blocked in a space has a restriction in providing a content in connection with the motion of the user.

Nevertheless, the virtual content experience device that uses the HMD device provides a virtual space to the user and enables the user to experience virtual contents which are hard to be provided by augmented reality, various auxiliary devices have been developed and released to solve the problem of restricting the motion of the user.

Generally, the contents for providing virtual reality photograph and use a real image or provide fine virtual reality graphics. As a public virtual experience, there are comics contents in which the story is expressed with the conventional 2-dimensional images. Even though the comics contents are not complex virtual reality graphics, considering the nature of the conventional comics contents that provide a certain degree of a three-dimensional effect, it is expected that the user satisfaction is fulfilled only with the virtual reality that provides a certain degree of immersive feeling. The digital comics using continual images that construct a story line can provide a story line to the user.

Recently, the comics service is evolving as a service to provide a sense of realism as if a user is positioned in the inner story space of digital comics which are not confined as a planar image shape. A sphere toon may be defined as a comics flatform that provides digital comics contents such as a webtoon using virtual reality. A sphere toon application is installed on a smartphone and an HMD device is mounted such that a screen is constructed to enjoy the sphere toon. In this case, characters, background, objects, and the like of a webtoon are expressed, which are provided in the sphere toon application, and the layers for the objects are differently disposed and implemented.

To implement such a sphere toon, each of the layers is preconfigured, and an object is disposed on the respective layer. Such a method of implementing a sphere toon corresponds to a method of preconfiguring the disposition of each object and disposing the object. To show a 2-dimensional image to a stereoscopic image, backgrounds and the respective objects are separately configured, and to change a screen configuration, each of the objects needs to be reconfigured. Accordingly, there is a restriction in changing the screen configuration.

As another way of implementing a stereoscopic image, based on images obtained using two cameras, each of the images are transferred to both eyes of a user that mounts the HMD device. According to the schemes described above, to convert a fixed 2-dimensional image to a stereoscopic image, it needs to be considered that a screen configuration of multiple-stage is required or a method is used to obtain an image in a stereoscopic scheme.

If a hand-drawn 2-dimensional image is easily converted to a stereoscopic image, the digital comics contents using the HMD device may be provided in more various manners.

As an auxiliary device to the HMD device, various devices have been developed to experience virtual reality in such a way that a user sits thereon or the HMD device is fixed to the auxiliary device. However, the auxiliary device requires a driving device of complex structure and a sturdy system, the auxiliary device is very expensive, and therefore, a normal user is hard to purchase it. In a fixed type of virtual content experience device using the HMD device, since a stimulus important for sight is transferred in a state that a user motion is restricted, nausea may be caused by the sense discrepancy between the static organ and the sight, and it is regarded as another problem to solve the discordance between a motion of sight and a somatic sense.

While digital comics contents are easily provided in stereoscopic images, the device that provides a regular somatic sense to experience the stereoscopic images is not based on reality, and there is a restriction in providing the whole complex feelings. Furthermore, the provision of virtual reality that reflects motions needs to be separately implemented for each content. To experience fine virtual reality, a fine dedicated experiencing device needs to be provided, and an expensive equipment to control motions in accordance with the contents is required.

### DISCLOSURE

### Technical Problem

A purpose of an embodiment of the present disclosure is to provide a virtual content experience system for transferring a somatic sense in relation to a 3-dimensional image to a user by extracting a binocular disparity angle according to a degree of the 3D feeling to obtain according to the binocular disparity principle, which is the principle of recognizing 3D, from a sheet of 2D image from a depth image, generating an image of which viewing angle is different by rearranging an original image according to the extracted angle, providing a modified image and the original image as a stereoscopic image pair and generating a 3D image for the HMD device from the 2D image, and converting a word, a sentence, a sign, and the like included in the 2D image to somatic sense and providing the and providing.

The technical objects of the present disclosure are not limited to the technical objects described above, and other technical effects not mentioned herein may be understood to those skilled in the art to which the present disclosure belongs from the description below.

### TECHNICAL SOLUTIONS

The virtual content experience system to solve the technical problem, wherein a central server for driving the system includes: a content conversion unit for converting a 2-dimensional (2D) image content received from a data transmission/reception unit or inputted from a user through a data input unit into a stereoscopic image according to a preconfigured method; a motion information generation unit for recognizing text information extracted from the 2D image content and converting the text information to motion information; a content playback control unit for generating and modifying control information that controls whether to provide a new 2D image content by transmitting the motion information to a motion information management unit provided in a virtual reality experiencing chair or receiving start information and end information of the motion information from the motion information management unit and; and a display unit for displaying the content conversion unit, the motion information, or the control information on a user window.

In one embodiment, the motion information generation unit may convert state information received from an HMD device thorough the data transmission/reception unit into the motion information.

In one embodiment, the motion information may be transmitted to a control unit for controlling at least one servo motor provided in a virtual reality experience chair, and the virtual reality experience chair may perform an operation corresponding to the motion information.

In one embodiment, the stereoscopic image may be generated by generating a first panorama image which is equirectangular with respect to a 360-degree space; extracting a depth image from the first panorama image; generating a left-eye image by matching the first panorama image and the depth image to a square cube map including a front surface, a left surface, a rear surface, a right surface, a top surface, and a bottom surface; partitioning a region overlapped by the consecutive images of the front surface, the left surface, the rear surface, and the right surface of the cube map image from the first panorama image into 2D images of a preconfigured equal interval; and generating a first stereoscopic right-eye image by preconfigured algorithm for the partitioned 2D images.

In one embodiment, the HMD device may be provided to generate position information included in the state information and position modification information, and the HMD device may include: a sensor for sensing a gaze direction of a user; a display unit for displaying a virtual screen to the user; a screen control unit for configuring a first criterion for the gaze direction of the user based on the sensor; a data transmission/reception unit for transmitting the virtual screen projected on a virtual space based on the first criterion to the user; a rotation detection unit for determining whether a rotation angle of the gaze direction of the user with respect to a pitch direction is greater than a first threshold value and less than a second threshold value in comparison with the first criterion; a rotation limit detection unit for determining whether a moving distance in the gaze direction of the user with respect to a Y-axis direction is greater than a third threshold value; a position information generation unit for generating the position information when the rotation angle of the gaze direction of the user with respect to the pitch direction is greater than the first threshold value and less than the second threshold value and the moving distance of in the gaze direction of the user with respect to the Y-axis direction is greater than the third threshold value in comparison with the criterion, and the posture of user is determined to be lying down; and a position modification information generation unit for generating the position modification information inquiring whether to set a new the second criterion with respect to the gaze direction of the user when the posture of user is determined to be lying down.

A method for controlling a virtual content experience system according to another aspect of the present disclosure includes: converting, by a content conversion unit of a service server, a 2-dimensional (2D) image content received from a data transmission/reception unit or inputted from a user through a data input unit into a stereoscopic image according to a preconfigured method; recognizing, by a motion information generation unit of the service server, text information extracted from the 2D image content and converting the text information to motion information; generating and modifying, by a content playback control unit of the service server, control information that controls whether to provide a new 2D image content by transmitting the motion information to a motion information management unit provided in a virtual reality experiencing chair or receiving start information and end information of the motion information from the motion information management unit and; and displaying, by a display unit of the service server, the content conversion unit, the motion information, or the control information on a user window.

### ADVANTAGEOUS EFFECTS

According to an embodiment of the present disclosure, a virtual content experience system may be provided for transferring a somatic sense in relation to a 3-dimensional image to a user by extracting a binocular disparity angle according to a degree of the 3D feeling to obtain according to the binocular disparity principle, which is the principle of recognizing 3D, from a sheet of 2D image from a depth image, generating an image of which viewing angle is different by rearranging an original image according to the extracted angle, providing a modified image and the original image as a stereoscopic image pair and generating a 3D image for the HMD device from the 2D image, and converting a word, a sentence, a sign, and the like included in the 2D image to somatic sense and providing the and providing.

The technical effects of the present disclosure are not limited to the technical effects described above, and other technical effects not mentioned herein may be understood to those skilled in the art to which the present disclosure belongs from the description below.

### DESCRIPTION OF DRAWINGS

FIG. 1 is a system block diagram illustrating a server of the virtual content experience system according to an embodiment of the present disclosure.

FIG. 2 is a flowchart of a method for controlling the virtual content experience system according to another embodiment of the present disclosure.

FIGS. 3 and 4 are diagrams illustrating an overall system configuration of the present disclosure.

FIG. 5 is a diagram illustrating a system block diagram of the present disclosure.

FIG. 6 is a flowchart illustrating a method of generating a 3D image for the HMD device from a 2D image according to an embodiment of the present disclosure.

FIG. 7 is a system configuring diagram according to an embodiment of the present disclosure.

FIG. 8A and FIG. 8A are a diagram illustrating a 360-degree panorama image and a depth image therefor.

FIG. 9 is a diagram illustrating an equirectangular projection with respect to a 360-degree panorama image

FIG. 10 is a diagram illustrating a cube map to which a 360-degree panorama image is mapped.

FIG. 11 is a diagram illustrating an area in which the front surface, the left surface, the bottom surface, and the right surface of the cube map in the equirectangular projection.

FIG. 12 is a conceptual diagram illustrating a left-eye image and a right-eye image generated by using the depth image.

FIG. 13 is a diagram illustrating a distance from an actual object corresponding to a depth image.

FIGS. 14 to 17 are exemplary diagrams of a method of generating a 3D image for the HMD device from a 2D image according to another embodiment of the present disclosure.

### BEST MODE

Objects and effects of the present invention and technical configurations for achieving them will become apparent with reference to embodiments described in detail below in conjunction with the accompanying drawings. In the following description of the present invention, known functions or configurations will not be described in detail when it is determined that the gist of the present invention may be unnecessarily obscured thereby. The following terms are defined in consideration of the functions in the present invention and may vary depending on the intentions or customs of a user or operator.

However, the present invention is not limited to the embodiments disclosed below and may be implemented in various other ways. The embodiments are provided so that the disclosure of the present invention will be thorough and complete and will fully convey the scope of the invention to those of ordinary skill in the art. The scope of the present invention is only defined by the claims. Therefore, definitions should be based on the overall content of this specification.

Throughout the specification, when a part is referred to as “including” or “having” a certain component, this does not preclude other components and units that other components may further be included unless stated to the contrary. Also, terms, such as “unit,” “part,” and “module,” refer to units for processing at least one function or operation, and such units may be implemented with hardware, software, or a combination of hardware and software.

Meanwhile, in exemplary embodiments of the present invention, each of components, functional blocks, or units may include one or more sub-components, and electrical, electronic, and mechanical functions performed by the components may be implemented as various known devices or mechanical components including an electronic circuit, an integrated circuit, an application specific integrated circuit (ASIC) and the like. The components may be separately implemented, or two or more of the components may be integrated into one. Also, combinations of each block in the accompanying block diagram and each step in the flowchart may be performed by computer program instructions. These computer program instructions may be loaded into the processor of a general-purpose computer, special-purpose computer, portable notebook computer, network computer, mobile device such as a smart phone, an online game service providing server, or other programmable data processing equipment, so that the instructions executed by a processor of a computer device or other programmable data processing equipment perform the functions described in each block of the block diagram or each step of the flowchart to be described below. It creates the means to do it. These computer program instructions may also be stored in a memory or computer readable memory available to a computer device that may direct a computer device or other programmable data processing equipment to implement a function in a particular manner, so that each block in the block diagram or it is also possible to produce articles of manufacture containing instruction means for performing the functions described in each step of the flowchart. The computer program instructions may also be mounted on a computer device or other programmable data processing equipment, thereby creating a process for performing a series of operational steps on the computer device or other programmable data processing equipment, so it is possible to create a process for performing a series of operational steps on a computer device or other programmable data processing equipment to provide steps for executing the functions described in each block in the block diagram and in each step in the flowchart.

Further, each block or each step may represent a module, segment, or portion of code that includes one or more executable instructions for executing the specified logical function(s). It should also be noted that in some alternative embodiments it is also possible for the functions recited in blocks or steps to occur out of order. For example, it is possible that two blocks or steps shown one after another may in fact be performed substantially simultaneously, or that the blocks or steps may sometimes be performed in the reverse order according to the corresponding function.

In exemplary embodiments of the present invention, a user device unit any calculation unit for collecting, reading, handling, processing, storing, and displaying data such as a desktop computer, a laptop computer, a smart phone, and a cellular phone. In particular, the user device in exemplary embodiments of the present invention is a device having a function of executing software written in interpretable code and displaying and transferring the software being executed to a user. Also, as necessary, the user device may store the software therein or read the software together with data from the outside.

Also, the user device in exemplary embodiments of the present invention may include not only the above data processing function but also functions of input, output, storage, and the like. To this end, the user device may include not only various elements, such as a central processing unit (CPU), a mainboard, a graphics card, a hard disk drive, a sound card, a speaker, a keyboard, a mouse, a monitor, a universal serial bus (USB) terminal, and a communication modem, that general computing devices have but also a CPU, a mainboard, a graphics chip, a memory chip, a sound engine, a speaker, a touchpad, an external connection terminal, such as a USB terminal, a communication antenna, a communication modem for performing third generation (3G), Long Term Evolution (LTE), LTE-advanced (LTE-A), Wi-Fi, Bluetooth, etc. communication, and the like that wireless smart phone terminals have. Such elements may be used alone or in combination of two or more or parts of the elements may be combined to implement one or more functions.

Devices, which are illustrated as one or more blocks in the drawings or detailed description according to exemplary embodiments of the present invention, or parts of the devices may represent one or more functions which are provided by various elements included in the user device alone or in combination of two or more or combined parts of the elements. Meanwhile, in exemplary embodiments of the present invention, the user device, etc. may have a communication function and have various networking units, such as wired Internet, wireless Internet, infrared communication, Bluetooth, wideband code division multiple access (WCDMA), wireless broadband (WiBro), Wi-Fi, LTE, LTE-A, 3G, fourth generation (4G), fifth generation (5G), and a wired or wireless telephone network, to perform the communication function.

Hereinafter, a virtual content experience system according to an embodiment of the present disclosure will be described with reference to the accompanying drawings.

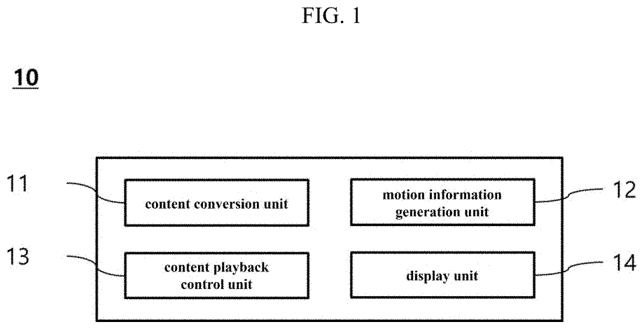

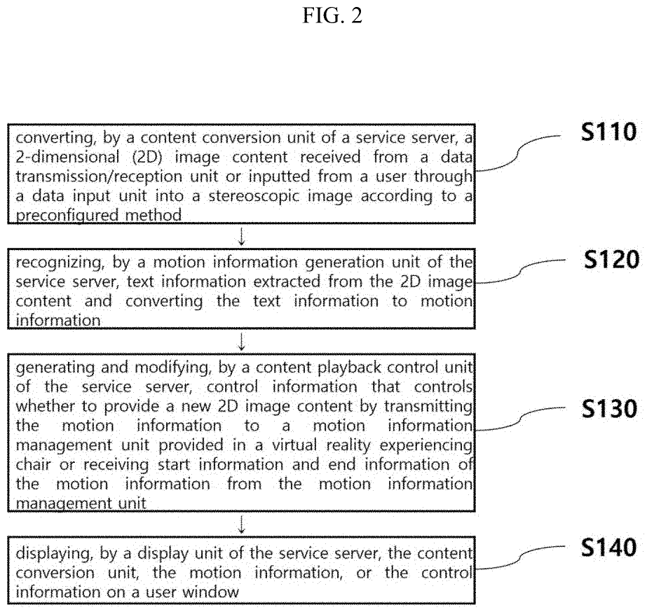

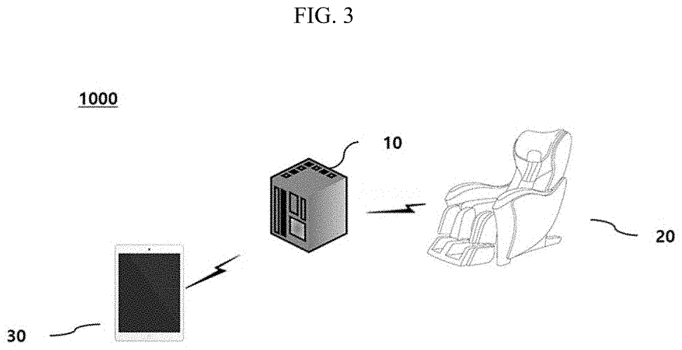

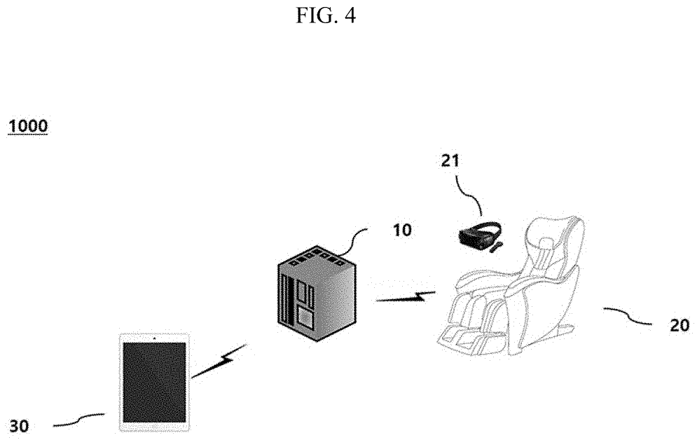

FIG. 1 is a system block diagram illustrating a server of the virtual content experience system according to an embodiment of the present disclosure, and FIG. 2 is a flowchart of a method for controlling the virtual content experience system according to another embodiment of the present disclosure. FIG. 3 is a diagram illustrating an overall system configuration of the present disclosure.

Referring to FIG. 1, the server according to an embodiment of the present disclosure includes a content conversion unit, a motion information generation unit, a content playback control unit, and a display unit.

Specifically, in the virtual content experience system, a central server 10 for driving the system includes a content conversion unit 11 for converting a 2-dimensional (2D) image content received from a data transmission/reception unit or inputted from a user through a data input unit into a stereoscopic image according to a preconfigured method; a motion information generation unit 12 for recognizing text information extracted from the 2D image content and converting the text information to motion information; a content playback control unit 13 for generating and modifying control information that controls whether to provide a new 2D image content by transmitting the motion information to a motion information management unit provided in a virtual reality experiencing chair or receiving start information and end information of the motion information from the motion information management unit and; and a display unit 14 for displaying the content conversion unit, the motion information or the control information on a user window.

First, the content conversion unit may convert the 2D image content to be converted to be projected in a 3-dimensional (3D) manner in a virtual spear space centered on a gaze of the user. However, the stereoscopic image may be converted such that each individual entity may have 3D effect in addition to configure the space in a 3D manner.

The motion information generation unit may be provided to recognize the text information extracted from the 2D image content and convert the text information to the motion information. For example, the 2D image may be an existing comics content, which often explains a situation in a text on speech bubbles or around a picture. The text may describe the surrounding situation, a motion of main character, a movement of surrounding terrain, and a movement of a passenger or a boarding tool of a specific vehicle. The text may be expressed as an onomatopoeia, a pseudo-word, and the like in addition to an ordinary verb and a noun, and the motion information generation unit may interpret the text information in physical language to generate the motion information so that the virtual experience chair may move according to the information of the text without operating of separate system driving program.

Next, the motion information generation unit may be provided to convert the state information received from the HMD device thorough the data transmission/reception unit into the motion information. As a kind of feedback information, the motion of a user measured based on the movement of the HMD device mounted on the user is reflected in the motion information and the motion information may be generated to restrict the movement of the virtual experience chair or provide the movement for maximizing the virtual experience.

For this, the HMD device may include a sensor provided to generate position information included in the state information and position modification information and sense a gaze direction of a user; a display unit for displaying a virtual screen to the user; a screen control unit for configuring a first criterion for the gaze direction of the user based on the sensor; a data transmission/reception unit for transmitting the virtual screen projected on a virtual space based on the first criterion to the user; a rotation detection unit for determining whether a rotation angle of the gaze direction of the user with respect to a pitch direction is greater than a first threshold value and less than a second threshold value in comparison with the first criterion; a rotation limit detection unit for determining whether a moving distance in the gaze direction of the user with respect to a Y-axis direction is greater than a third threshold value; a position information generation unit for generating the position information when the rotation angle of the gaze direction of the user with respect to the pitch direction is greater than the first threshold value and less than the second threshold value and the moving distance of in the gaze direction of the user with respect to the Y-axis direction is greater than the third threshold value in comparison with the criterion, and the posture of user is determined to be lying down; and a position modification information generation unit for generating the position modification information inquiring whether to set a new the second criterion with respect to the gaze direction of the user when the posture of user is determined to be lying down.

By using the means described above, since the posture may be changed according to the direction viewed by the user, by driving the virtual reality experience chair that reflects the posture change, the user may feel the space like an actual space rather than a virtual space.

The motion information transmitted from the server is transmitted to the control unit for controlling at least one servo motor provided in the virtual reality experience chair and the virtual reality experience chair moves corresponding to the motion information.

The user may input a specific content through the data input unit with sitting in the virtual reality experience chair and the content is provided as a 3D image, and the situation included the in image is generated as the motion information and the virtual reality experience chair is driven so that the user may experience the content simply and 3-dimensionally. The stereoscopic image may be implemented in a planar image shape in a sphere centered on the gaze of the user, but not limited thereto, and in the case that each object or landscape is provided, the object itself may be converted and provided to have the 3D effect.

Specifically, in describing the method of converting a 2D image to a stereoscopic image such that each of the objects has the 3D effect, the stereoscopic image may be generated by a step generating a first panorama image which is equirectangular with respect to a 360-degree space; a step extracting a depth image from the fist panorama image; a step generating a left-eye image by matching the first panorama image and the depth image to a square cube map including a front surface, a left surface, a rear surface, a right surface, a top surface, and a bottom surface; a step of partitioning a region overlapped by the consecutive images of the front surface, the left surface, the rear surface, and the right surface of the cube map image from the first panorama image into 2D images of a preconfigured equal interval; and a step of generating a first stereoscopic right-eye image by preconfigured algorithm for the partitioned 2D images. Hereinafter, a method of generating a 3D image for the HMD device from a 2D image will be described in detail with reference to the accompanying drawings.

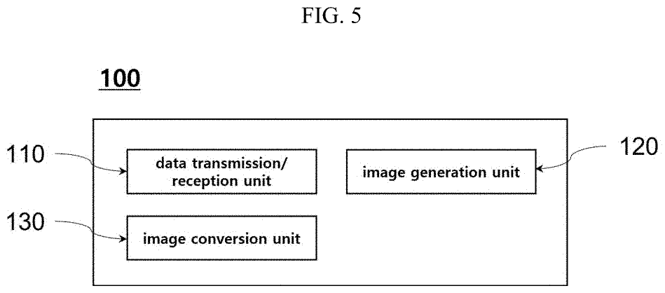

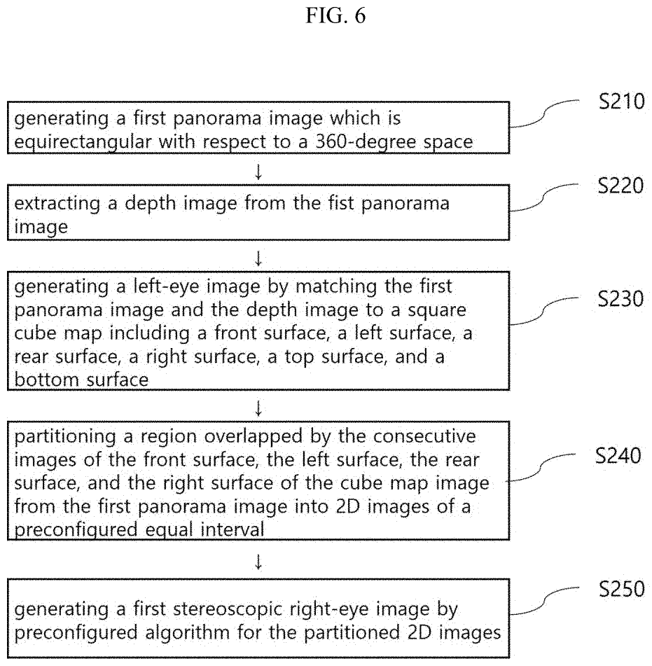

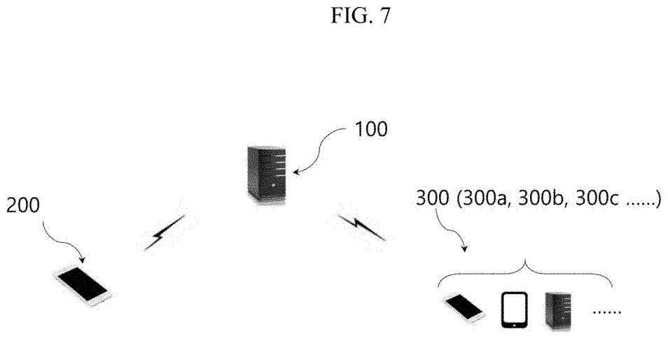

FIG. 5 is a diagram illustrating a system block diagram of the present disclosure, and FIG. 6 is a flowchart illustrating a method of generating a 3D image for the HMD device from a 2D image. FIG. 7 is a system configuring diagram.

Referring to FIG. 5 to FIG. 7, the method of generating a 3D image for the HMD device from a 2D image may be performed by a user device or a service server that relays a user and a third party.

The user device or the service server is provided to transmit and receive various types of information in a wired/wireless manner to be used for the method of generating a 3D image for the HMD device from a 2D image or to transmit a left-eye or right-eye image to the HMD device. Next, the image generation unit may be provided to generate an image such as the case of mapping a panorama image to be used for the method generating a 3D image for the HMD device from a 2D image or mapping a panorama image to a cube map. The image conversion unit may be provided to extract a depth image or to partition the generated image in the preset manner.

Referring to FIG. 7, in the case that the method of generating a 3D image for the HMD device from a 2D image is performed by the service server 100, the service server 100 processes and edits the image information transmitted from a user device and transmits the image information to a third user device so that a user of the third user device may enjoy the 3D image through the HMD device.

Referring to FIG. 6, the method of generating a 3D image for the HMD device from a 2D image according to an aspect of the present disclosure to solve the technical problem includes a step of generating the first panorama image which is equirectangular with respect to a 360-degree space (step S210).

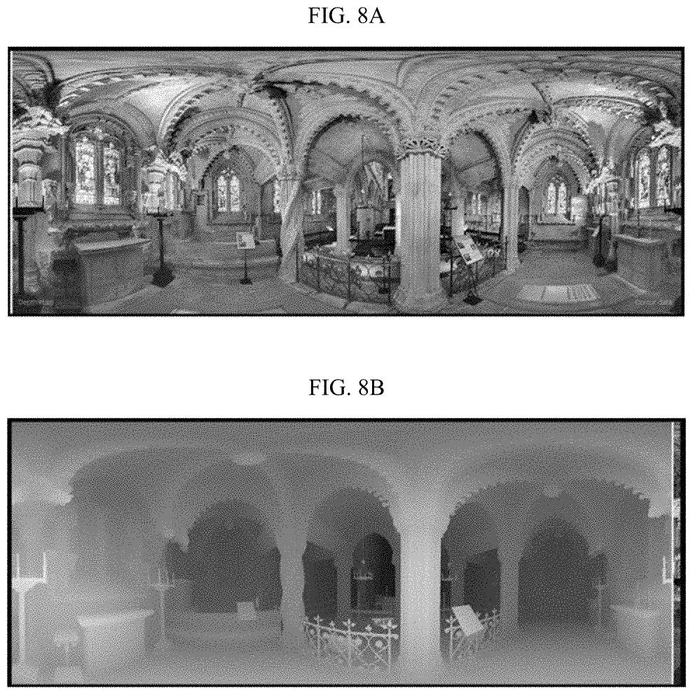

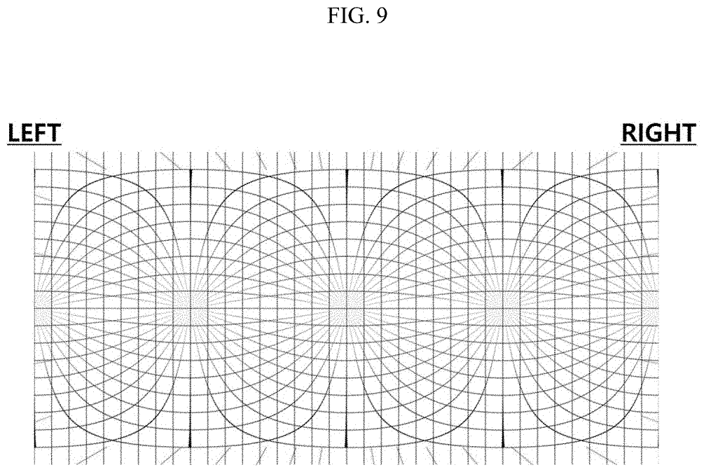

The first panorama image may be received from the user device and used. Referring to FIG. 8A, FIG. 8B, and FIG. 9, the first panorama image may be an image that expresses a 360-degree space starting from the left surface which is the starting point of the image and may be provided to be ended in the right surface which is the last point of the image.

Referring to FIG. 8A, FIG. 8B, and FIG. 9, it is identified that a 360-degree panorama image is expressed in the equirectangular projection in which a 3D space is expresses in a single plane.

Thereafter, the method includes a step of extracting a depth image from the first panorama image (step S220).

In FIG. 8A and FIG. 8B, it is identified that FIG. 8B corresponding to the depth image is extracted from FIG. 8A, which is an example of the first panorama image. Referring to FIG. 8A and FIG. 8B, the first panorama image, as a color image, may be partitioned into pixels of a region having different depth values. The first panorama image may be expressed as a depth image to apply different contrasts and utilize a degree of each of the contrasts as information for a depth value. In this case, the degree of contrast may be provided to be represented as n integers (n≥0) according to the configured manner.

Next, the method includes a step of generating a left-eye image by matching the first panorama image and the depth image to a square cube map including a front surface, a left surface, a rear surface, a right surface, a top surface, and a bottom surface (step S230).

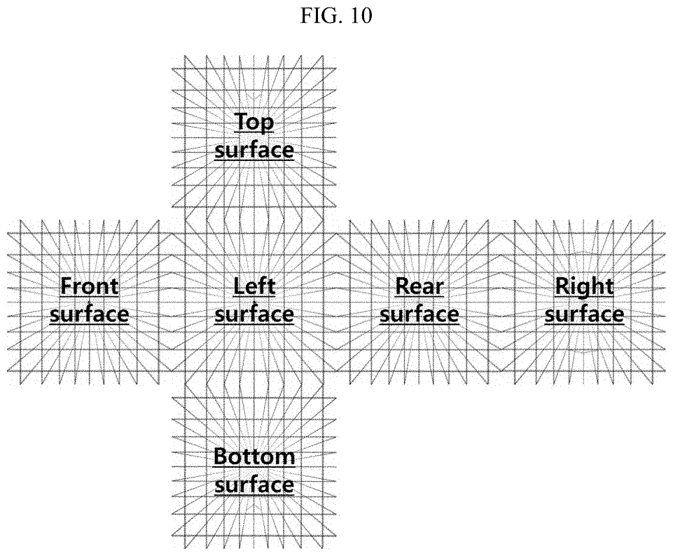

Referring to FIG. 10, it may be identified the first panorama image is distinguished into a total of 6 images when the first panorama image represented in the equirectangular projection.

The cube map may be used by matching the cube map to the image corresponding to the front surface, the left surface, the rear surface, the right surface, the top surface, and the bottom surface.

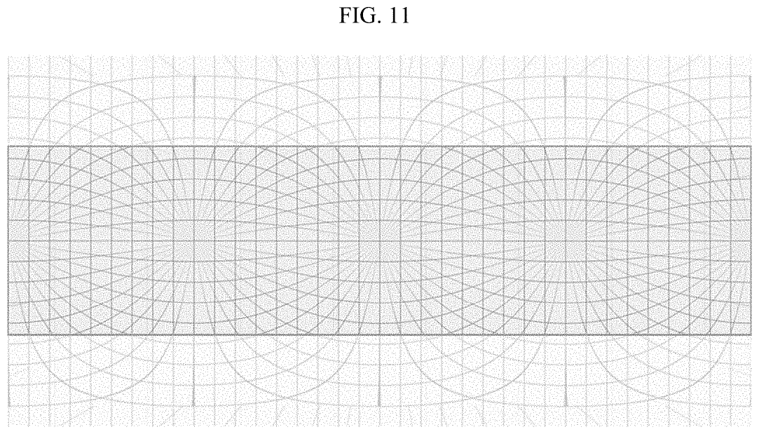

FIG. 11 is a diagram illustrating an area in which the front surface, the left surface, the bottom surface, and the right surface of the cube map in the equirectangular projection. Referring to FIG. 7, it is identified that the part of expressing the consecutive surface of the front surface, the left surface, the rear surface, and the right surface of cube map excluding the top surface and the bottom surface on the first panorama image represented in the equirectangular projection is shaded.

The method of generating a 3D image for the HMD device from a 2D image is to express the 3D effect of an image in a direction viewed by a user, and since a definition of left/right-eye is changed according to the change in the gaze of the user in the case of an upper space and a lower space based on the user, the depth value may be applied only to the four areas in the middle including the front surface, the left surface, the rear surface, and the right surface, excluding the depth value application area.

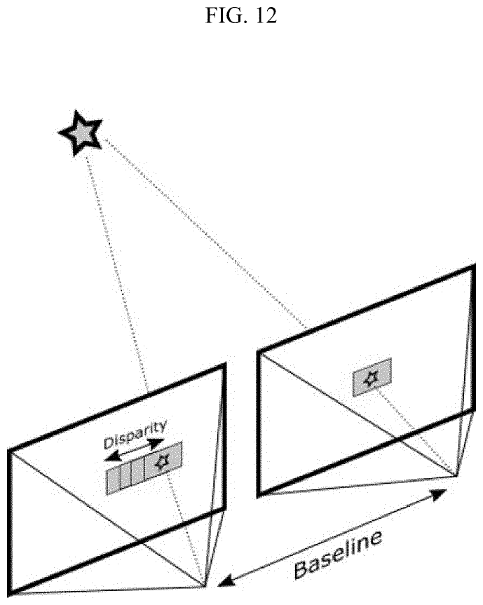

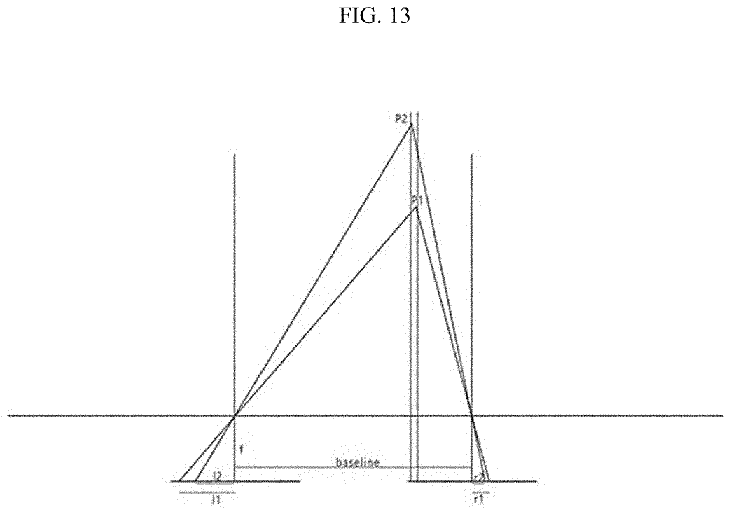

FIG. 12 is a conceptual diagram illustrating a left-eye image and a right-eye image generated by using the depth image, and FIG. 13 is a diagram illustrating a distance to an actual object corresponding to the depth image.

Referring to FIG. 12 and FIG. 13, a disparity of the left/right-eye image may be calculated by using a baseline corresponding to the distance between left and right eyes and a distance between a first object P1 and a second object P2. That is, it is identified that the disparity value (11−r1>12−r2) of the first object P1 which is relatively close is greater than that of the second object P2, and by using this, the left-eye image may be generated by using method of adjusting a pixel position of an input image corresponding to a preset depth value.

Next, the method includes a step of partitioning overlapping continuous image of front surface, left surface, rear surface, and right surface of the cube map image from the first panorama image into 2D image of preset equal interval is included (step S240).

The entire right-eye image for the first panorama image is not generated while the left-eye image is fixed, but each of the areas of the front surface, the left surface, the rear surface, and the right surface of the matched cube map is equally partitioned, and the left-eye and right-eye images may be generated for each partition areas. In this case, each of the areas may be partitioned in a 45-degree interval corresponding to ⅛ of the entire 360-degree space. However, the partitioning is not limited thereto, and the area may be partitioned in a proper equal interval as necessary. Next, the method includes a step generating a first stereoscopic right-eye image according to preconfigured algorithm with respect to the partitioned 2D image (step S250). Specifically, the right-eye image may be generated using the distance corresponding to a distance between the left-eye image and both eyes and a distance from an object. In addition, a definition of the baseline between both left/right-eyes which is a separately given operation environment variable apart from input image and a distance f value between of the eyes and an image area are required, and it is preferable that information for the longest distance and the shortest distance from the object is provided together.

In general, since a distance from a screen is about 1 to 2 m in user's sense for a VR device such as the HMD device and the like, it is preferable that the longest distance is smaller than about 2 m, and the shortest distance is also set to be greater than the focal distance (distance between a lens to an eye) provided in device. Preferably, a distance between the object and the left-eye or right-eye is less than or equal to about 1.5 m and greater than a distance between a lens of the HMD device and the left-eye or right-eye.

The method of generating a 3D image for the HMD device from a 2D image may further include a step of providing the left-eye image and the first stereoscopic right-eye image as the left and right images to be applied to the HMD device, respectively.

The respective images provided as the left and right images may be transmitted to the third user and displayed on the left-eye and the right-eye of the HMD device, respectively, and the third user may enjoy a stereoscopic image.

According to the method of generating a 3D image for the HMD device from a 2D image, a depth image is extracted from one panorama image, each image is expressed in the equirectangular projection and divided into the remaining image except top and bottom images in the case of being matched to the cube map, this is converted to the panorama image of the equirectangular projection, and this is equally divided, and generated as the left image and the right images, and therefore, a 3D image which may be played in the HMD device may be provided using one 2D image.

A method of generating a 3D image for the HMD device from a 2D image according to another embodiment of present disclosure includes a step of generating a second panorama image which is equirectangular for a 360-degree space.

The second panorama image may correspond to a 2D image drawn directly by a user. As a preferable example, depth image information may be extracted from the first panorama image. However, the present disclosure is not limited thereto, and a user may create the depth image information randomly and generate a left-eye or right-eye image together with the second panorama image.

To generate an image for transmitting the 3D effect by representing the second panorama image on the first panorama image described above, the method may include a step of inputting equirectangular depth image information for a 360-degree space extracted from the first panorama image corresponding to the second panorama image.

Next, the method includes a step of separating areas having different depth values by using the depth image information from the second panorama image.

The depth image information extracted from the first panorama image is provided as a depth value for a distinguished image which is expressed on the second panorama image and may be converted to a 3D image harmonized with the first panorama image.

The method includes a step of generating a left-eye image by matching the separated area with n (n≥0, integer) square cube maps including a front surface, a left surface, a rear surface, a right surface, a top surface, and a bottom surface.

The cube map is two or more images having various depth values and may be provided as a left-eye image for delivering the 3D effect.

Next, the method includes a step of generating a second stereoscopic right-eye image by preconfigured algorithm for the left-eye image.

The right-eye image may be generated by a proportional equation using a distance between both two eyes of a user corresponding to a distance between lenses of both eyes of the HMD device and a distance (depth value) between at least one object.

In this case, the method may include a step of providing the left-eye image and the second stereoscopic right-eye image as left and right-eye images to be applied to the HMD device, respectively. The left-eye image and the right-eye image may be provided as one image having the 3D effect to the user wearing the HMD device using a visual difference.

In addition, the preconfigured equal interval may be eight equal parts of the first panorama image which is equirectangular for the 360-degree space. For example, the entire right-eye image for the first panorama image is not generated while the left-eye image is fixed, but each of the areas of the front surface, the left surface, the rear surface, and the right surface of the matched cube map is equally partitioned, and the left-eye and right-eye images may be generated for each partition areas. In this case, each of the areas may be partitioned in a 45-degree interval corresponding to ⅛ of the entire 360-degree space.

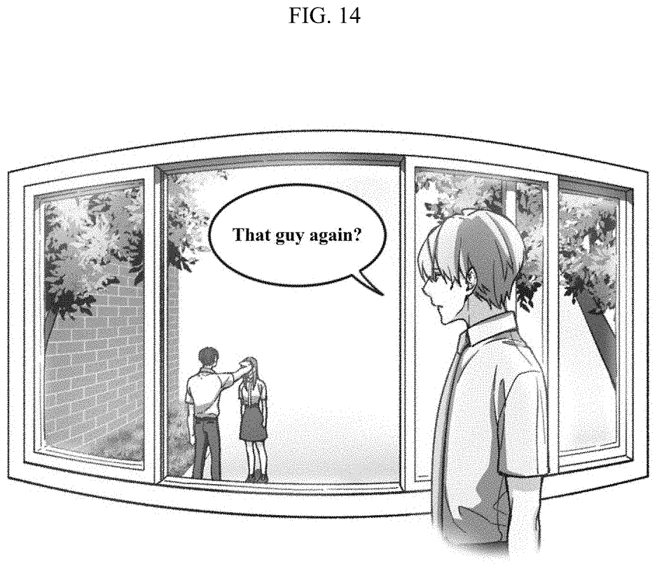

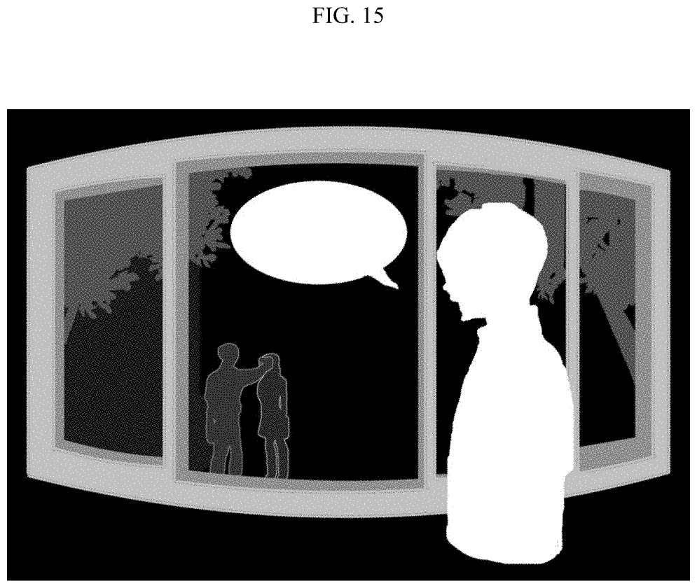

FIG. 14 to FIG. 17 are exemplary diagrams of a method of generating a 3D image for the HMD device from a 2D image according to another embodiment of the present disclosure. Referring to FIG. 14 to FIG. 17, first, a panorama image is generated, which represents consecutive images including a front surface, a left surface, a rear surface, and a right surface, excluding an area corresponding to a top and a bottom of the one cube map, which is expressed in the equirectangular projection. Next, a depth image extracted from the panorama image is exemplified in FIG. 15. The depth image may be converted to depth information of a preset value for each object on the panorama image and used to implement a depth degree for each object. Next, a left-eye image and a right-eye image may be generated, respectively, through a proportional equation using a distance between both eyes of a user and a distance from the respective object.

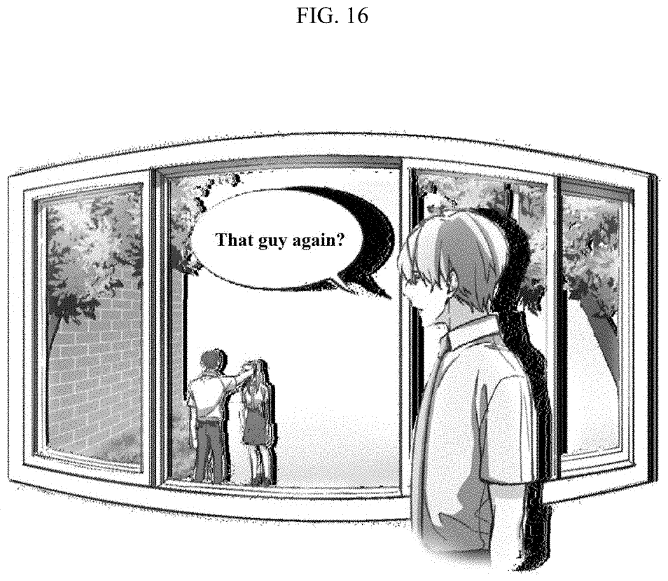

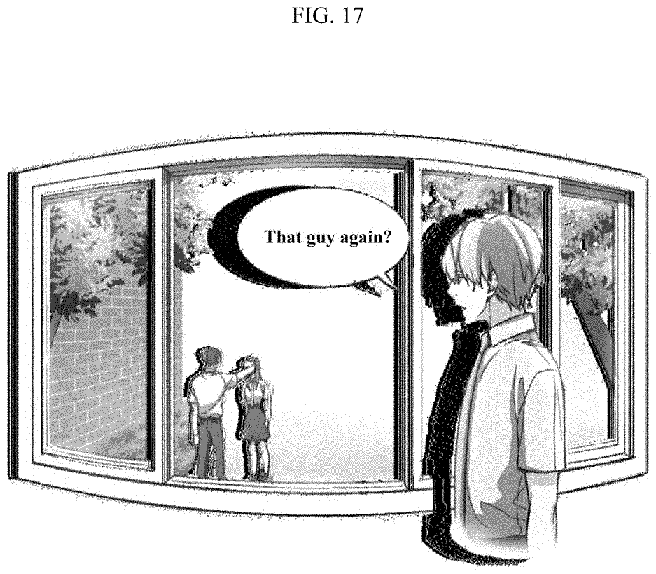

FIG. 16 illustrates a left-eye image using the algorithm through a proportional equation, and FIG. 17 illustrates a right-eye image using the algorithm of a proportional equation. In the case that each image is provided to left-eye/right-eye lenses of the HMD device, respectively, this may be provided as one image in which the 3D effect is expressed in each object of different depth.

That is, one panorama image according to the equirectangular projection is matched to the cube map, and then, the left-eye and right-eye images are provided according to the preconfigured algorithm after the panorama image is converted to the consecutive images including a front surface, a left surface, a rear surface, and a right surface, excluding an area corresponding to a top and a bottom of the one cube map, a VR image having the 3D effect may be provided through the HMD device from one image even in the case of requiring excessive computer power.

According to another embodiment of the present disclosure, instead of the steps of inputting the one 360-degree panorama image to a user device, further inputting a depth image for providing a depth value to each object of the panorama image, matching the panorama image and the depth image to the cube map, respectively, panorama-imaging the value excluding the value of the top surface and bottom surface image, and using this, but a user may input the image of the front surface, the left surface, the rear surface, and the right surface corresponding to an image in the horizontal direction of the cube map and the corresponding depth image information to the user device from the beginning, and accordingly, generated as a new panorama image. The new panorama image provided as such may be provided to be converted as the left-eye image and the right-eye image from the proportional equation using the depth value of the object expressed on the image, a distance between both eyes of the user, and a virtual line in the horizontal direction with the user. The detailed algorithm is as exemplified in the described above, and omitted herein. In the case of generating a 3D image for the HMD device from a 2D image according to another embodiment of the present disclosure and using it as a 3D image, one 360-degree image inputted and edited by a user is easily converted to the left-eye image and the right-eye image to be provided to the HMD device, and there is an advantage that the contents having 3D effect may be provided easily. Particularly, in the case that the contents provided in the method are applied to a 2D digital comics of which design is provided by an artist, the contents may be provided as image having 3D effect through the HMD device, and accordingly, there is great applicability.

In the disclosure and the drawings, the preferred embodiment of the present invention is disclosed. Although specific terms are used herein, the terms are just used in the general meanings to easily describe the description of the invention and help understanding of the invention, but not intended to limit the scope of the present invention. It is understood that the other modified examples based on the inventive concept of the present invention is also able to be embodied as well as the embodiment disclosed herein to those of ordinary skilled in the art to which the present invention pertains.

1. A virtual content experience system, wherein a central server for driving the system comprising:
a content conversion unit for converting a 2-dimensional (2D) image content received from a data transmission/reception unit or inputted from a user through a data input unit into a stereoscopic image according to a preconfigured method;
a motion information generation unit for recognizing text information extracted from the 2D image content and converting the text information to motion information;
a content playback control unit for generating and modifying control information that controls whether to provide a new 2D image content by transmitting the motion information to a motion information management unit provided in a virtual reality experiencing chair or receiving start information and end information of the motion information from the motion information management unit and; and
a display unit for displaying the content conversion unit, the motion information, or the control information on a user window.

2. The virtual content experience system of claim 1, wherein the motion information generation unit converts state information received from an HMD device thorough the data transmission/reception unit into the motion information.

3. The virtual content experience system of claim 1, wherein the motion information is transmitted to a control unit for controlling at least one servo motor provided in a virtual reality experience chair, and the virtual reality experience chair performs an operation corresponding to the motion information.

4. The virtual content experience system of claim 1, wherein the stereoscopic image is generated by generating a first panorama image which is equirectangular with respect to a 360-degree space; extracting a depth image from the first panorama image; generating a left-eye image by matching the first panorama image and the depth image to a square cube map including a front surface, a left surface, a rear surface, a right surface, a top surface, and a bottom surface;
partitioning a region overlapped by the consecutive images of the front surface, the left surface, the rear surface, and the right surface of the cube map image from the first panorama image into 2D images of a preconfigured equal interval; and
generating a first stereoscopic right-eye image by preconfigured algorithm for the partitioned 2D images.

5. The virtual content experience system of claim 2, wherein the HMD device is provided to generate position information included in the state information and position modification information, and
wherein the HMD device includes: a sensor for sensing a gaze direction of a user; a display unit for displaying a virtual screen to the user; a screen control unit for configuring a first criterion for the gaze direction of the user based on the sensor; a data transmission/reception unit for transmitting the virtual screen projected on a virtual space based on the first criterion to the user; a rotation detection unit for determining whether a rotation angle of the gaze direction of the user with respect to a pitch direction is greater than a first threshold value and less than a second threshold value in comparison with the first criterion; a rotation limit detection unit for determining whether a moving distance in the gaze direction of the user with respect to a Y-axis direction is greater than a third threshold value; a position information generation unit for generating the position information when the rotation angle of the gaze direction of the user with respect to the pitch direction is greater than the first threshold value and less than the second threshold value and the moving distance of in the gaze direction of the user with respect to the Y-axis direction is greater than the third threshold value in comparison with the criterion, and the posture of user is determined to be lying down; and a position modification information generation unit for generating the position modification information inquiring whether to set a new the second criterion with respect to the gaze direction of the user when the posture of user is determined to be lying down.

6. A method for controlling a virtual content experience system, the method comprising:
converting, by a content conversion unit of a service server, a 2-dimensional (2D) image content received from a data transmission/reception unit or inputted from a user through a data input unit into a stereoscopic image according to a preconfigured method;
recognizing, by a motion information generation unit of the service server, text information extracted from the 2D image content and converting the text information to motion information;
generating and modifying, by a content playback control unit of the service server, control information that controls whether to provide a new 2D image content by transmitting the motion information to a motion information management unit provided in a virtual reality experiencing chair or receiving start information and end information of the motion information from the motion information management unit and; and
displaying, by a display unit of the service server, the content conversion unit, the motion information, or the control information on a user window.

7. A storage medium storing a program for performing the method for controlling a virtual content experience system of claim 6.
